(19) United States
(12) Patent Application Publication
(10) Pub. No.: US 2007/0169397 A1
(43) Pub. Date: Jul. 26, 2007

(54) Buoyant spoon type fishing lure

(76) Inventor: Michael Ruben Mieczkowski, Spring Lake, MI (US)

Correspondence Address: MICHAEL R. MIECZKOWSKI, 18025 WEST SPRING LAKE RD., SPRING LAKE, MI, 49456, US

(21) Appl. No.: 11/307,144

(22) Filed: Jan. 25, 2006

(51) Int. Cl. A01K 85/14

(52) U.S. Cl. 43/42.5

(57) ABSTRACT

This invention pertains to new buoyant spoon type fishing lures. The fishing spoon itself is comprised of a buoyant plastic of composite material. The spoon type lure has both concave and convex surfaces which gives the spoon its wobbling action and to which coloring, texture or markings would be affixed, attached or imbedded. Because of its floating tendency, in line weights may be added if desired. Weight attached to a three way swivel may also be used. This allows the spoon to remain in the water column when the weight is sitting on the bottom. The length of line attached to the three way swivel lets the angler know exactly where the lure is when stopped.

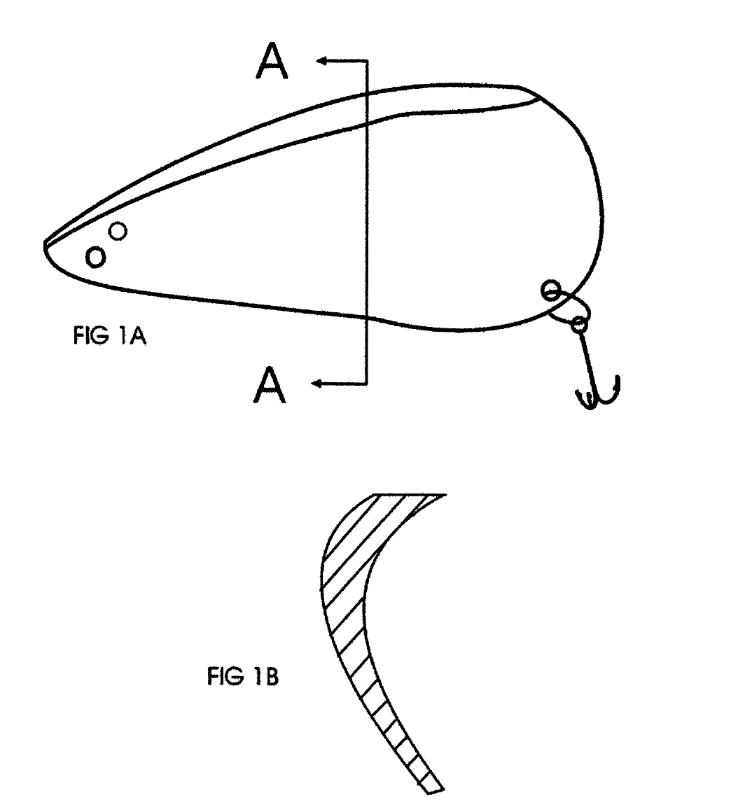

### GENERAL

This invention relates to spoon type fishing lures. Spoon type lures are a separate lure type, differing from all other fishing lures such as the stick bait and crank bait (commonly called body baits), spinner baits which have a blade or blades attached to a wire, and jig baits which typically have a lead head attached to a hook.

### BACKGROUND

A fishing lures is made for one basic function, to attract fish, allowing an angler or fisher to hook and land fish for food, sport or other purposes. Fishing lures differ in basic size, weight, shape, composite, design and function. Additional features, excluding colors, include mechanisms to produce noise or vibrations, to hold and/or release attractants.

Fishing ‘spoons’ are so named because of their similarity to the ordinary eating spoon and are perhaps the oldest know type of artificial bait. Spoons are generally made of metal and can be cast, drifted, jigged or trolled. Due to their weight, a typical steady, fast retrieve is necessary to preclude snagging a spoon on the bottom or in structure. This retrieve does not necessarily match the feeding mood of the quarry. If during a retrieve, the angler paused, the spoon merely fluttered or plunged downward effectively causing a loss of control and a possible loss of the spoon. If this intentional pause was an attempt to initiate a second strike from a missed fish, the spoon drops unnaturally out of that strike zone.

Body type lures have a distinct advantage over spoon type lures because they can be manufactured to suspend. A pause allows the lure to remain in the initial strike zone thus allowing the possibility of a second strike from a missed fish. Spoons, up until this point, were a disadvantage because of this suspending possibility.

### FIELD

Because of this spoons buoyant capability as explained in the abstract, once a retrieve is slowed or stopped, the spoon will either maintain its position (suspend) or change its position (float upwards), effectively matching that of body baits. This action is exactly opposite relative to “standard” metal spoons which simply freefall to the bottom, heavy end first.

During fabrication of the buoyant fishing spoon, the spoon suspends horizontally in the water which mimics that of a bait fish, giving it a back and belly, if you will. The manufacturing process gives the lure its initial ‘set’ in the water column, positive buoyancy or neutral buoyancy. If the spoon is placed down into the water and it stays there, the ‘set’ would be considered neutral and the spoon will suspend there. If after the same placement, the spoon begins to rise toward the surface, the ‘set’ would be considered positive (buoyant). The spoon could also be manufactured with a slight negative buoyancy which would allow a countdown possibility where it would slowly sink down into the water column. During a retrieve, which is typically horizontal or slightly downward, stopping or pausing the retrieve will allow the spoon to remain within the relative strike zone you are fishing.

The top (back) of the spoon is manufactured with a wider and flatter profile than the bottom (belly) which allows the spoon to dive when retrieved. The spoon will contain rings in both the leading edge for line attachment and in the trailing end for attaching of the hook.

### SUMMARY

The spoon will be manufactured in varying sizes and will entertain stamped, affixed or imbedded designs, colors and markings. If an angler wishes to use this spoon in a traditional type fashion (metal spoon), line weights, rigging, hook size and self-stick weights can be added to allow it to perform in a negative ‘set’ (sink). This spoon is unmistakably the most advanced fishing spoon invented and will appeal to all species of fish in both the fresh and salt water arenas.

What is claimed is:

1. A buoyant fishing lure compromising:
a spoon type design,
of positive buoyancy,
of varying sizes,
of texture, markings and color to one or both sides,
with or without a ring attached to the leading end,
a ring attached to the trailing end,
a single or plurality of barbs affixed to the trailing ring.
